(19) United States
(12) Patent Application Publication
(10) Pub. No.: US 2015/0224908 A1
(43) Pub. Date: Aug. 13, 2015

(54) Trailer Hitch Extension Apparatus

(71) Applicant: Jonathon Colvin, Colt, AR (US)

(72) Inventor: Jonathon Colvin, Colt, AR (US)

(21) Appl. No.: 14/177,730

(22) Filed: Feb. 11, 2014

(51) Int. Cl. B60P 3/10; B60D 1/155

(52) U.S. Cl. CPC B60P 3/1083; B60D 1/155

(57) ABSTRACT

A trailer hitch extension apparatus including an extension bar with a proximal end, a distal end, an identical right and left side and an identical top and bottom side. The proximal end slidingly engages and alternately disengages a trailer hitch bar. A ball mount coupler is disposed on the distal end. A plurality of equally spaced apart apertures are centrally disposed on the right and left sides. The apertures are in alignment to securingly receive an attachment member through each aperture on each respective side. The extension bar slidingly engages the trailer hitch bar forwardly and alternately rearwardly. Upon the forward and alternate rearward sliding engagement of the extension bar, a distance between a boat trailer and a boat being towed on the trailer, increases and alternately decreases.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

Be it known that I have invented new and useful improvements in a trailer hitch extension apparatus as described in this specification.

### BACKGROUND OF THE INVENTION

Various types of trailer hitch assemblies are known in the prior art. However, what is needed is a trailer hitch extension apparatus including a hollow parallelepiped extension bar with a proximal end and a distal end. The proximal end slidingly engages and alternately disengages a trailer hitch bar. A ball mount coupler is disposed on the distal end. A plurality of equally spaced apart apertures are centrally disposed on two identical sides of the extension bar. The apertures are in alignment to securingly receive an attachment member through each aperture on each respective side. The extension bar slidingly engages the trailer hitch bar forwardly and alternately rearwardly. Upon the forward and alternate rearward sliding engagement of the extension bar, a distance between a boat trailer and a boat being towed on the trailer, increases and alternately decreases. The distance provides assistance while launching a boat in a body of water having a low water level relative to a boat ramp. Currently, when a user launches a boat from a boat trailer into a body of water having a low water level relative to a boat ramp, the user must back a vehicle with the attached boat trailer further into the said body of water, creating potential hazards such as becoming stuck in mud or the vehicle taking on too much water and potentially becoming stuck. The present device allows the user to disengage the attachment member before launching the boat. The user then pulls the said vehicle forward, which forwardly slidingly engages of the extension bar providing the needed distance between the vehicle and the boat trailer. The user then replaces the attachment member to secure the extension bar at the desired distance before launching. The sliding forward engagement extends the distance from eighteen inches to fifty-four inches. The present device eliminates the potential of the said hazards and provides an easier alternative to the current standards of launching the boat.

### FIELD OF THE INVENTION

The present invention relates to trailer hitch assemblies, and more particularly, to a trailer hitch extension apparatus devised to launch a boat from a boat ramp into a body of water having a low water level relative to the boat ramp.

### SUMMARY OF THE INVENTION

The general purpose of the present trailer hitch extension apparatus, described subsequently in greater detail, is to provide a trailer hitch extension apparatus which has many novel features that result in a trailer hitch extension apparatus which is not anticipated, rendered obvious, suggested, or even implied by prior art, either alone or in combination thereof.

To accomplish this, the present trailer hitch extension apparatus devised to launch a boat from a boat ramp into a body of water having a low water level relative to the boat ramp thereby eliminating the potential for getting the vehicle pulling the trailer and the trailer stuck in mud at the end of the boat ramp. The instant apparatus includes a hollow parallelepiped extension bar having a top side and a bottom side. The bottom side is identical to the top side. There is a right side and a left side. The left side is identical to the right side. There is a proximal end and a distal end. The distal end is identical to the proximal end. A continuous inner cavity is disposed between the top, bottom, right and left sides.

A plurality of equally spaced apart, one half inch apertures are centrally disposed on each of the right and left sides at an interval of eighteen inches.

An attachment member, securingly slidingly engages one of the apertures on each of the right side and respective left sides in a position perpendicular to the extension bar. The attachment member when disengaged allows the proximal end of the extension bar to slidingly engage and alternately disengage a trailer hitch bar. The extension bar slidingly engages the trailer hitch bar forwardly and alternately rearwardly. Upon the forward and alternate rearward sliding engagement of the extension bar, a distance between a boat trailer and a boat being towed on the trailer increases and alternately decreases. The distance provides assistance while launching a boat in a body of water having a low water level relative to a boat ramp.

A ball mount coupler is disposed on the distal end. The ball mount coupler is configured to attach to a ball hitch on a vehicle.

Thus has been broadly outlined the more important features of the present trailer hitch extension apparatus so that the detailed description thereof that follows may be better understood and in order that the present contribution to the art may be better appreciated.

### BRIEF DESCRIPTION OF THE DRAWINGS

### Figures

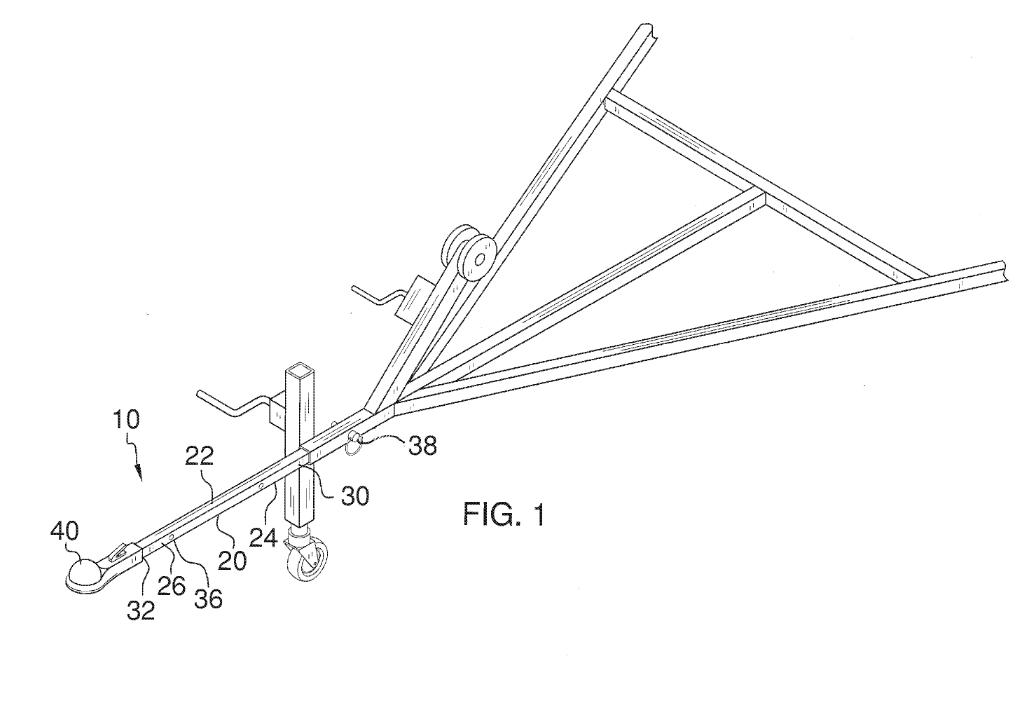

FIG. 1 is an isometric in-use view.

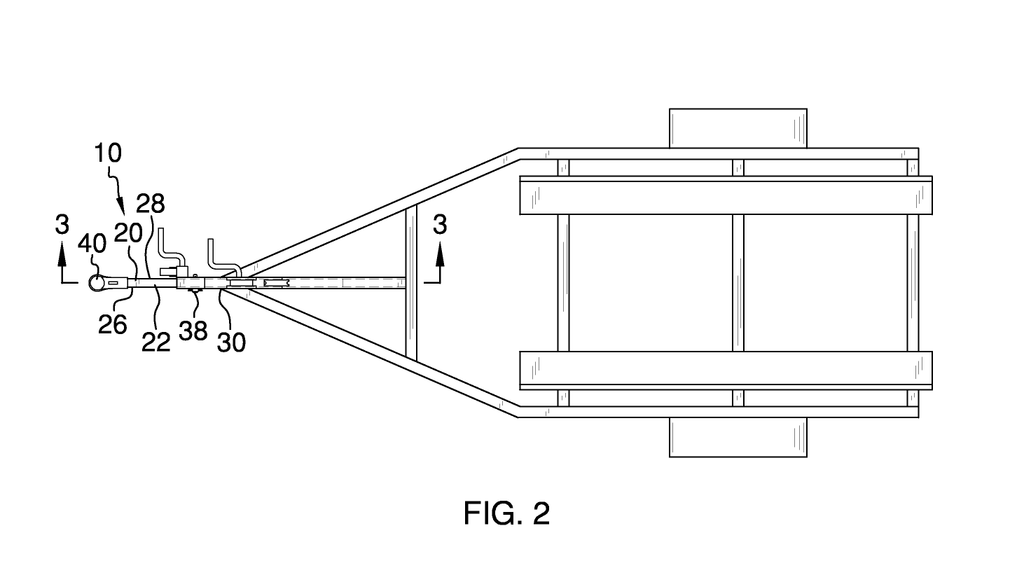

FIG. 2 is an in-use top plan view.

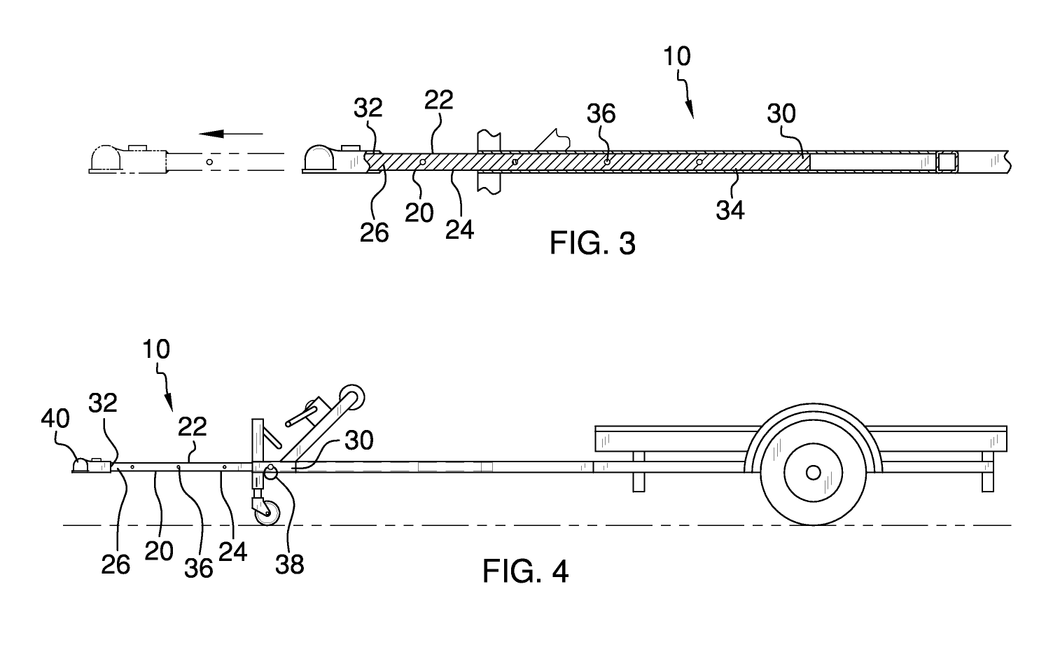

FIG. 3 is a cross-sectional view taken along line 3-3 of FIG. 2.

FIG. 4 is an in-use side elevation view.

### DETAILED DESCRIPTION OF THE DRAWINGS

With reference now to the drawings, and in particular FIGS. 1 through 4 thereof, an example of the instant trailer hitch extension apparatus employing the principles and concepts of the present trailer hitch extension apparatus and generally designated by the reference number 10 will be described.

Referring to FIGS. 1 through 4 the present trailer hitch extension apparatus 10 is illustrated. The trailer hitch extension apparatus 10 includes a hollow parallelepiped extension bar 20 having a top side 22 and a bottom side 24. The bottom side 24 is identical to the top side 22. There is a right side 26 and a left side 28. The left side 28 is identical to the right side 26. There is a proximal end 30 and a distal end 32. The distal end 32 is identical to the proximal end 30. A continuous inner cavity 34 is disposed between the top, bottom, right and left sides 22, 24, 26, 28.

A plurality of equally spaced apart, one half inch apertures 36 are centrally disposed on each of the right and left sides 26, 28 at an interval of eighteen inches.

An attachment member 38, securingly slidingly engages one of the apertures 36 on each of the right side 26 and respective left sides 28 in a position perpendicular to the extension bar 20. The attachment member 38 when disengaged allows the proximal end 30 of the extension bar 20 to slidingly engage and alternately disengage a trailer hitch bar. The extension bar 20 slidingly engages the trailer hitch bar forwardly and alternately rearwardly. Upon the forward and alternate rearward sliding engagement of the extension bar 20, a distance between a boat trailer and a boat being towed on the trailer increases and alternately decreases. The distance provides assistance while launching a boat in a body of water having a low water level relative to a boat ramp.

A ball mount coupler 40 is disposed on the distal end 32. The ball mount coupler 40 is configured to attach to a ball hitch on a vehicle.

1. A trailer hitch extension apparatus comprising:
a single length of hollow parallelepiped extension bar having a top side, a bottom side, the bottom side identical to the top side, a right side, a left side, the left side identical to the right side, a proximal end, a distal end, the distal end identical to and disposed opposite the proximal end, and a continuous inner cavity disposed therebetween, the extension bar having a same width continuously therealong from the proximal end to the distal end;
a plurality of equally spaced apart apertures centrally disposed on each of the right and left sides;
an attachment member, wherein the attachment member securingly slidingly engages one of the apertures on each of the right side and respective left sides in a position perpendicular to the extension bar; and
a ball mount coupler disposed on the distal end;
wherein the proximal end of the extension bar is configured to slidingly engage and alternately disengage a trailer hitch bar; and
further wherein the extension bar slidingly engages the trailer hitch bar forwardly and alternately rearwardly;
wherein upon the forward and alternate rearward sliding engagement of the extension bar, a distance between a boat trailer and a boat being towed on the trailer increases and alternately decreases.

2. The trailer hitch extension apparatus of claim 1 wherein the attachment member is a clevis pin.

3. The trailer hitch extension apparatus of claim 1 wherein each aperture in one half inch is diameter and eighteen inches apart.

4. The trailer hitch extension apparatus of claim 1 wherein the extension bar is comprised of three inch square tubing and each side is one quarter inch thick.

5. A trailer hitch extension apparatus comprising:
a single length of hollow parallelepiped extension bar having a top side, a bottom side, the bottom side identical to the top side, a right side, a left side, the left side identical to the right side, a proximal end, a distal end, the distal end identical to and disposed opposite the proximal end, and a continuous inner cavity disposed therebetween, the extension bar having a same width continuously therealong from the proximal end to the distal end;
a plurality of equally spaced apart apertures centrally disposed on each of the right and left sides;
an attachment member, wherein the attachment member securingly slidingly engages one of the apertures on each of the right side and respective left sides in a position perpendicular to the extension bar; and
a ball mount coupler disposed on the distal end;
wherein the proximal end of the extension bar is configured to slidingly engage and alternately disengage a trailer hitch bar; and
further wherein the extension bar slidingly engages the trailer hitch bar forwardly and alternately rearwardly;
wherein upon the forward and alternate rearward sliding engagement of the extension bar, a distance between a boat trailer and a boat being towed on the trailer increases and alternately decreases.
wherein the attachment member is a clevis pin;
wherein each aperture is one half inch in diameter and eighteen inches apart; and
wherein the extension bar is comprised of three inch square tubing and each side is one quarter inch thick.
